(19) United States
(12) Patent Application Publication
(10) Pub. No.: US 2010/0046625 A1
(43) Pub. Date: Feb. 25, 2010

(54) APPARATUS AND METHOD FOR VIDEO ENCODING AND DECODING

(75) Inventors: Kwan-Woong SONG, Seongnam-si (KR); Chang-Hyun LEE, Suwon-si (KR); Young-Hun JOO, Yongin-si (KR); Yong-Serk KIM, Seoul (KR); Dong-Gyu SIM, Seoul (KR); Jung-Hak NAM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/545,452

(22) Filed: Aug. 21, 2009

(30) Foreign Application Priority Data
Aug. 21, 2008 (KR) 10-2008-0082014

(51) Int. Cl. H04N 7/32

(52) U.S. Cl. 375/240.16; 375/240.12; 375/E07.123

(57) ABSTRACT

A method and apparatus for encoding an image based on a video sensor structure are provided. The method includes acquiring an image to be encoded; separating the acquired image into respective color components; creating a predicted image for each of the color components, and creating a residual image between the predicted image and the acquired image; and performing transform encoding on each of the color components individually by applying the residual image to a transformation formula.

### CROSS-REFERENCE TO RELATED APPLICATION

This application priority from Korean Patent Application No. 10-2008-082014, filed Aug. 21, 2008 in the Korean Intellectual Property Office, the entire disclosure of which is hereby incorporated by reference.

### BACKGROUND OF THE INVENTION

1. Field of the Invention

Apparatuses and method consistent with the present invention relate to encoding and decoding moving images, and more particularly, to performing video encoding and decoding on input images based on a video sensor structure.

2. Description of the Related Art

In general, when video encoding and decoding is performed, an image of a previous frame is stored and referenced in order to increase compression and decompression efficiency of images. In other words, in an image encoding or decoding process, a previously encoded or decoded image is stored in a frame buffer, and then referenced for encoding or decoding the current image frame.

During video encoding, compression is achieved by removing spatial redundancy and temporal redundancy in an image sequence. In order to eliminate the temporal redundancy, a reference picture region similar to a region of a currently encoded picture is searched for by using another picture located before or after the currently encoded picture as a reference picture, motion between the regions corresponding to the currently encoded picture and the reference picture is detected, and a residue between a predicted (or estimated) image obtained by performing motion compensation based on the detected motion and the currently encoded image is encoded.

Generally, a motion vector of the current block has a high correlation with a motion vector of a peripheral block. Therefore, in the related art motion prediction and compensation, a motion vector of the current block is predicted from a peripheral block, and only a residue, created by performing motion prediction on the current block, between an actual motion vector of the current block and a predicted motion vector predicted from the peripheral block is encoded, thereby reducing the number of bits that should be encoded. However, even when the residue between the actual motion vector of the current block and the predicted motion vector of the peripheral block is encoded, data corresponding to the motion vector residue should be encoded at every block subjected to motion prediction encoding.

Accordingly, there is a need for a method and apparatus capable of further reducing the number of bits generated, by more efficiently performing prediction encoding on the current block.

### SUMMARY OF THE INVENTION

An aspect of the present invention is to address at least the above-mentioned problems and/or disadvantages and to provide at least the advantages described below.

Exemplary embodiments of the present invention provide a video encoding/decoding apparatus and method for improving software and/or hardware complexity by using video sensor structure-based images as input images.

According to an aspect of the present invention, there is provided a method for encoding an image based on a video sensor structure. The method includes acquiring an image to be encoded; separating the acquired image into respective color components; creating a predicted image for each of the color components, and creating a residual image between the predicted image and the acquired image; and performing transform encoding on each of the color components individually by applying the residual image to a preset transformation formula.

According to another aspect of the present invention, there is provided a method for decoding an image based on a video sensor structure. The method includes performing inverse transform encoding on each of color components of an image; creating a restored image using a residual image and a compensated image; and making a full-color image by interpolation to display the image restored for each of the color components of the image.

According to another aspect of the present invention, there is provided an apparatus for encoding and decoding an image based on a video sensor structure. The apparatus includes an image acquisition unit which acquires an image to be encoded; an encoding unit which acquires a predetermined number of transform coefficients by copying pixels of a residual image in a vertical or horizontal direction, and expresses input pixels with a half of the acquired transform coefficients according to a correlation between the acquired transform coefficients; a decoding unit which creates a restored image using a residual image and a compensated image, and interpolates the restored image; and an image display unit for displaying the image interpolated by the decoding unit.

### BRIEF DESCRIPTION OF THE DRAWINGS

The above and other aspects of the present invention will be more apparent from the following detailed description of exemplary embodiments taken in conjunction with the accompanying drawings, in which:

FIG. 1 is a block diagram of a sensor-based video encoding apparatus according to an exemplary embodiment of the present invention;

FIG. 2 illustrates a specific image which is divided into respective color components according to an exemplary embodiment of the present invention;

FIGS. 3A and 3B illustrate subpixel-by-subpixel motion prediction according to an exemplary embodiment of the present invention;

FIG. 4 illustrates spatial pixel prediction according to an exemplary embodiment of the present invention;

FIGS. 5A to 5J illustrate examples of subpixel-by-subpixel motion prediction according to an exemplary embodiment of the present invention; and

FIG. 6 is a block diagram of a sensor-based video decoding apparatus according to an exemplary embodiment of the present invention; and

FIG. 7 is a flowchart illustrating a sensor-based video encoding method according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

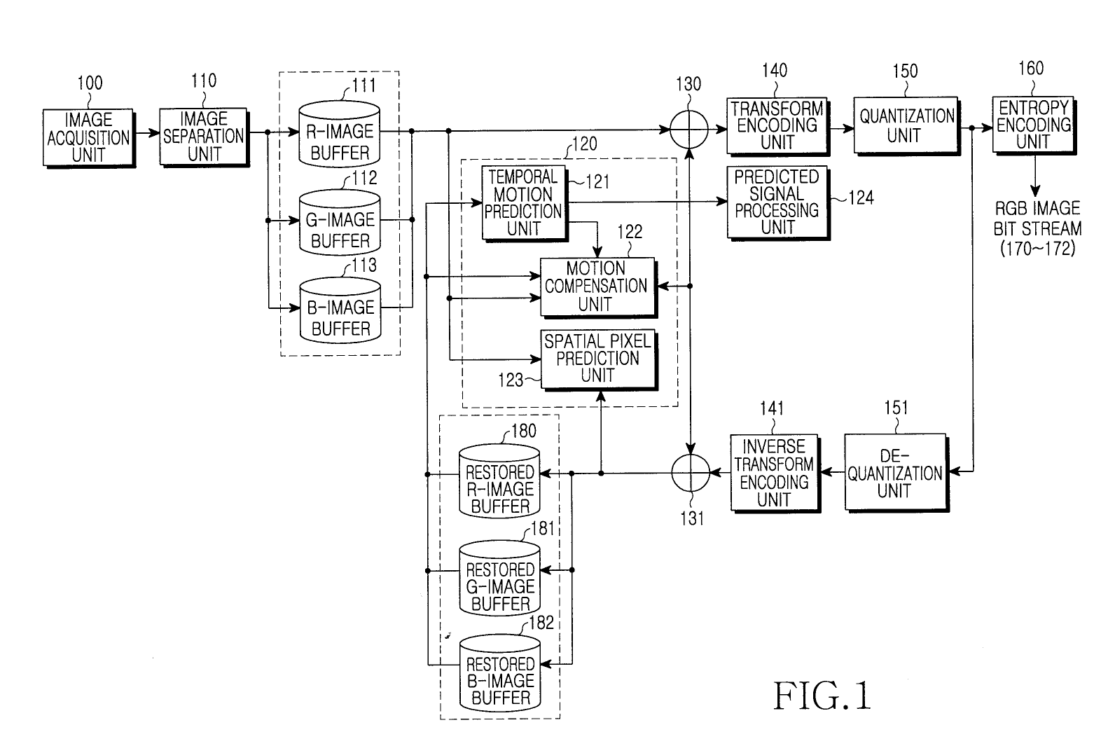

FIG. 1 is a block diagram of a sensor-based video encoding apparatus according to an exemplary embodiment of the present invention. The sensor-based video encoding apparatus includes an image acquisition unit 100, an image separation unit 110, an image buffer unit 115, a predicted image creation unit 120, a residual image creation unit 130, a transform encoding unit 140, a quantization unit 150, an entropy encoding unit 160, a dequantization unit 151, an inverse transform encoding unit 141, a restored image creation unit 131, and a restored image buffer unit 185. Functions of the respective elements will be described below with reference to FIG. 1.

The image acquisition unit 100 is a device for acquiring an image using a camera having a charge coupled device (CCD) sensor structure. An image has one color component per pixel, and each component is interpolated to express a three-color (RGB) image. Those of ordinary skill in the art will recognize that a CCD sensor of a camera may have a different structure.

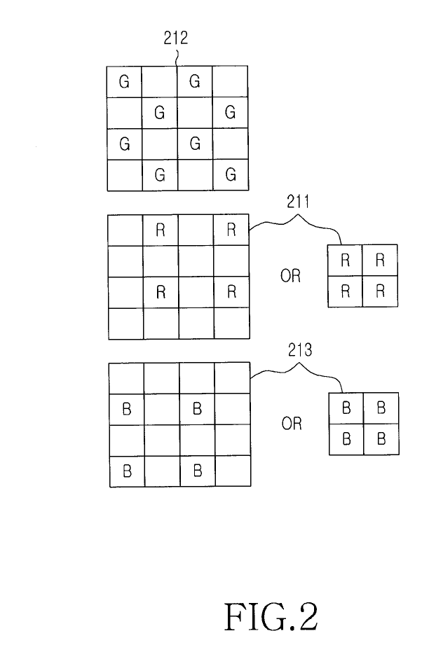

The image separation unit 110 separates an image received from the image acquisition unit 100 into respective components, i.e., a red (R) image, a green (G) image and a blue (B) image, and stores the R, G and B images in associated storage buffers 111, 112 and 113 of the image buffer unit 115. A format of an image which is separated into respective color components is illustrated in FIG. 2.

FIG. 2 illustrates a specific image which is divided into respective color components according to an exemplary embodiment of the present invention. In the example of FIG. 2, a green image 212 may have a form of a mosaic image as an input to an encoder, and the red image 211 and the blue image 213 may have a form of rectangular sample image, or normal image after down sampling, as inputs to the encoder. Various changes and modifications in separation and storage of the images are possible according to the structure or form of the sensor.

The predicted image creation unit 120 creates a temporal predicted image and/or a spatial predicted image for an image to be presently encoded or a block of a specific size. In particular, the predicted image creation unit 120 includes a temporal motion prediction unit 121, a motion compensation unit 122, and a spatial pixel prediction unit 123.

The temporal motion prediction unit 121 predicts time-dependent transformation in order to make the previous image identical to the current image. The motion compensation unit 122 creates the time-dependent prediction information predicted by the temporal motion prediction unit 121. During the temporal motion prediction and compensation based on a previous image, since both the previous reference image and the current image exist in a mosaic form, only the locations having a value are searched for in order to find out a block where optimal motion prediction is possible. The encoding apparatus of the exemplary embodiment supports motion prediction for the locations whose values are less than an integer pixel unit, like other encoders which are commonly used. This will be described with reference to the accompanying drawings.

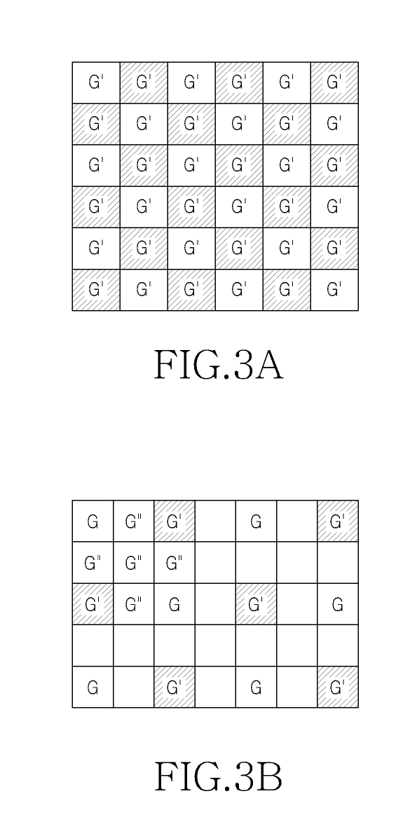

FIGS. 3A and 3B illustrate subpixel-by-subpixel motion prediction according to an exemplary embodiment of the present invention.

Referring to FIG. 3A, integer pixel parts (shaded parts) with no value in a reference image having a mosaic form are interpolated by the temporal motion prediction unit 121 using peripheral pixels, which corresponds to ½ pixel-by-½ pixel motion prediction. As shown in FIG. 3B, when ¼ pixel-by-¼ pixel motion prediction is needed, ¼-pixel motion prediction can be carried out by the temporal motion prediction unit 121 using the original mosaic pixels and the interpolated integer pixels. Such an interpolation method, including all possible related art interpolation methods, can be applied to the exemplary embodiments of the present invention.

The spatial pixel prediction unit 123, which uses peripheral blocks of the previously encoded current image, encodes the current image block using peripheral block values existing in a mosaic form and peripheral pixels. An example of this encoding will be described below.

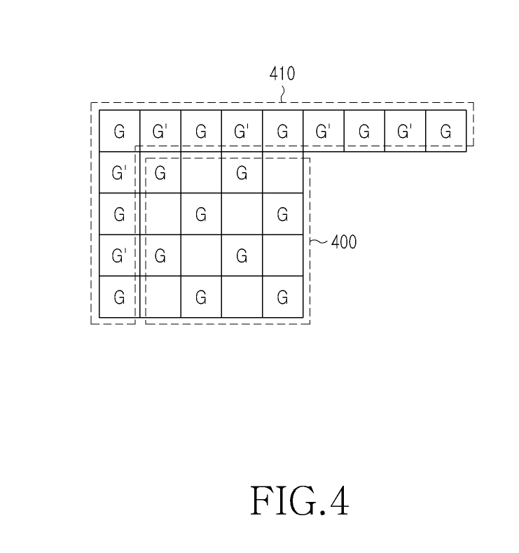

FIG. 4 illustrates spatial pixel prediction according to an exemplary embodiment of the present invention. In FIG. 4, the spatial pixel prediction unit 123 performs spatial pixel prediction on a current 4×4 image block 400 using normal pixels (in locations G) and interpolated pixels (in locations G′) existing in a peripheral block 410.

A predicted signal processing unit 124 ensures efficient prediction and improves compression efficiency of predicted signals through exchange of predicted information with the temporal motion prediction unit 121 of the predicted image creation unit 120 for each pixel.

The residual image creation unit 130 calculates a residual (or differential) image between the acquired optimal predicted image and the image to be encoded. The transform encoding unit 140, the quantization unit 150, and the entropy encoding unit 160 create encoded R, G and B image bit streams 170, 171 and 172 for the calculated residual image. The residual image having a mosaic form is input to the transform encoding unit 140, and a mosaic shape which is the same as that of the input is output, or transform coefficients, the number of which equals the number of input pixels, are output.

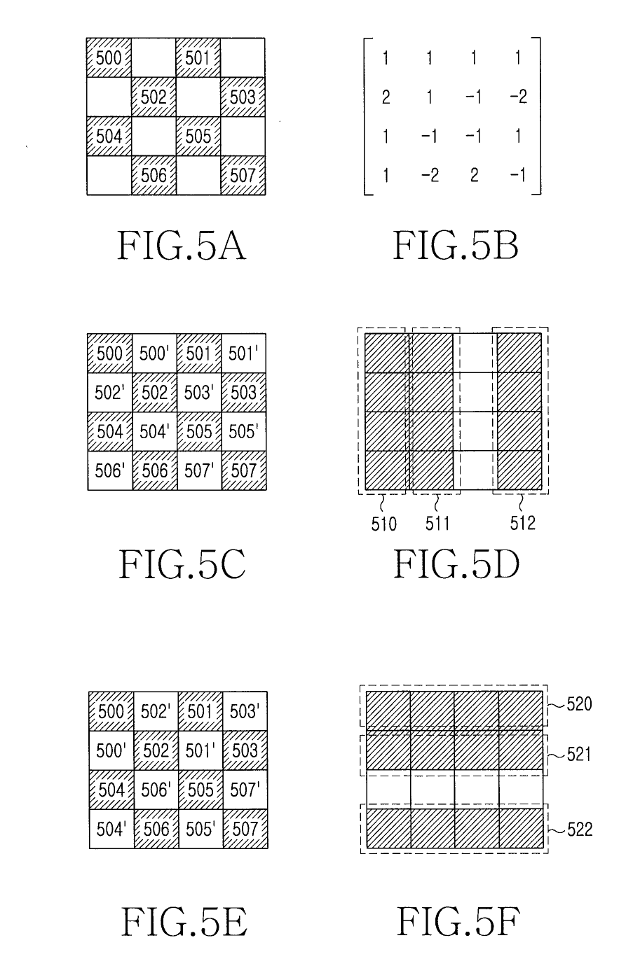

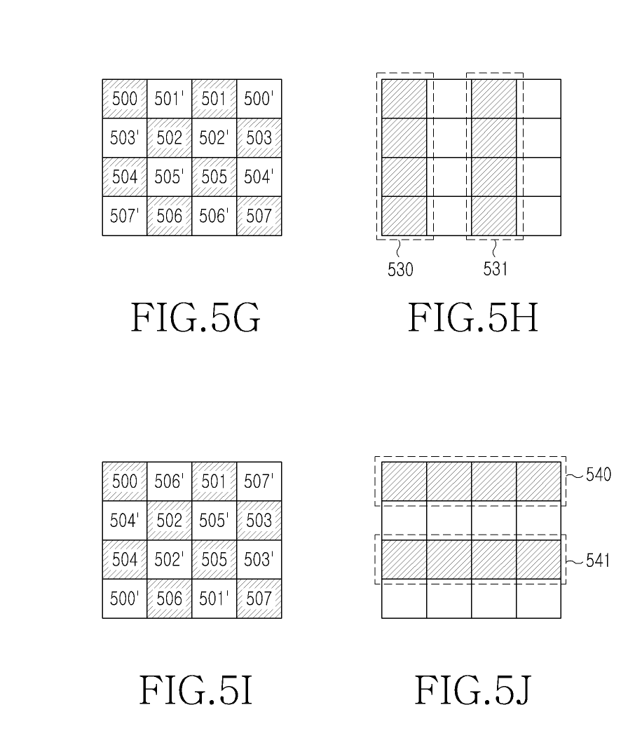

FIGS. 5A to 5J illustrate examples of subpixel-by-subpixel motion prediction according to an exemplary embodiment of the present invention.

Referring to FIG. 5A, 8 pixels having a mosaic form are used as input pixels 500˜507 for transform encoding. Here, 2×4, 4×2 and 4×4 transformation formulae can be freely used for transform encoding on 8 input pixels according to its use environment, and various other modifications and manipulations are possible. In this embodiment, examples of the 4×4 transformation formula will be described in detail.

Generally, 16 transform coefficients occur when a 4×4 transformation formula is used. However, in an exemplary embodiment of the present invention, a transform encoding method is used, in which 8 transform coefficients, the number of which equals to the number of input pixels, occurs fundamentally reducing complexity of the system. To this end, an exemplary embodiment of the present invention uses a 4×4 integer transformation formula of H.264/Advanced Video Coding (AVC) as a 4×4 transformation formula, as illustrated in FIG. 5B. In order to obtain 8 transform coefficients, the number of which equals the number of input pixels, pixels 500˜507 in the existing input mosaic form are copied in the horizontal direction and the vacant spaces are filled with the copied pixels 500′˜507, as shown in FIG. 5C.

If the input pixels of FIG. 5C are transformed with the transformation formula of FIG. 5B, 12 transform coefficients 510, 511 and 512 are created as shown in FIG. 5D. Here, transform coefficients in the third column all have a value of 0 by copying input pixels in the horizontal direction and then arranging them, and the transform coefficients 511 in the second column can be acquired by tripling the transform coefficients 512 in the fourth column. With use of this characteristic, the input pixels can be expressed with 8 transform coefficients.

In a similar method, the pixels 500˜507 in the existing input mosaic form are copied in the vertical direction as shown in FIG. 5E rather than being copied in the horizontal direction, and the vacant spaces are filled with the copied pixels 500′˜507′.

If the input pixels of FIG. 5E are transformed with the transformation formula of FIG. 5B, 12 transform coefficients 520, 521 and 522 are generated as shown in FIG. 5F. Similarly, transform coefficients in the third row all have a value of 0 by copying input pixels in the vertical direction and then arranging them, and the transform coefficients 521 in the second row can be acquired by tripling the transform coefficients 522 in the fourth row. With use of this characteristic, the input pixels can be expressed with 8 transform coefficients.

In another method, in order to obtain 8 transform coefficients, pixels in the first column are copied in the fourth column, pixels in the second column are copied in the third column, and the vacant spaces are filled with the copied pixels 500′˜507′ as shown in FIG. 5G. If the input pixels of FIG. 5G are transformed with the transformation formula of FIG. 5B, 8 transform coefficients 530 and 531 are generated as shown in FIG. 5H. As discussed above, all transform coefficients in the second and fourth columns have a value of 0 in accordance with the periodic feature of input pixels, making it possible to obtain 8 transform coefficients.

In a method similar to FIG. 5G, in order to obtain 8 transform coefficients, pixels in the first row are copied in the fourth row, pixels in the second row are copied in the third row, and the vacant spaces are filled with the copied pixels 500′˜507′ as shown in FIG. 5I. If the input pixels of FIG. 5I are transformed with the transformation formula of FIG. 5B, 8 transform coefficients 540 and 541 are generated as shown in FIG. 5J. Similarly, all transform coefficients in the second and fourth rows have a value of 0 in accordance with the periodic feature of input pixels, making it possible to obtain 8 transform coefficients.

In an exemplary embodiment of the present invention, input pixels are periodically arranged to obtain 8 transform coefficients, but various changes and modifications of the input pixels can be made by those skilled in the art to obtain 8 transform coefficients. In an alternative method, it is possible to acquire 8 transform coefficients by modifying the transform matrix shown in FIG. 5B instead of the input pixels.

The quantization unit 150 and the entropy encoding unit 160 create a bit stream by performing quantization and entropy encoding processes on the transform-encoding results output by the transform encoding unit 140. The color components may be subjected to independent encoding, thus generating different R, G and B image bit streams 170, 171 and 172.

The inverse transform encoding unit 141 and the dequantization unit 151 serve to perform decoding to restore the encoded image. The inverse transform encoding unit 141 and the dequantization unit 151 perform reverse processes of the transform encoding unit 140 and the quantization unit 150, respectively.

Finally, the restored image creation unit 131 creates a restored image using the decoded residual signal and the predicted image. The restored image creation unit 131 can create an individual restored image for each of the color components. The restored R, G and B images are stored in associated buffers 180, 181 and 182 of the restored image buffer unit 185.

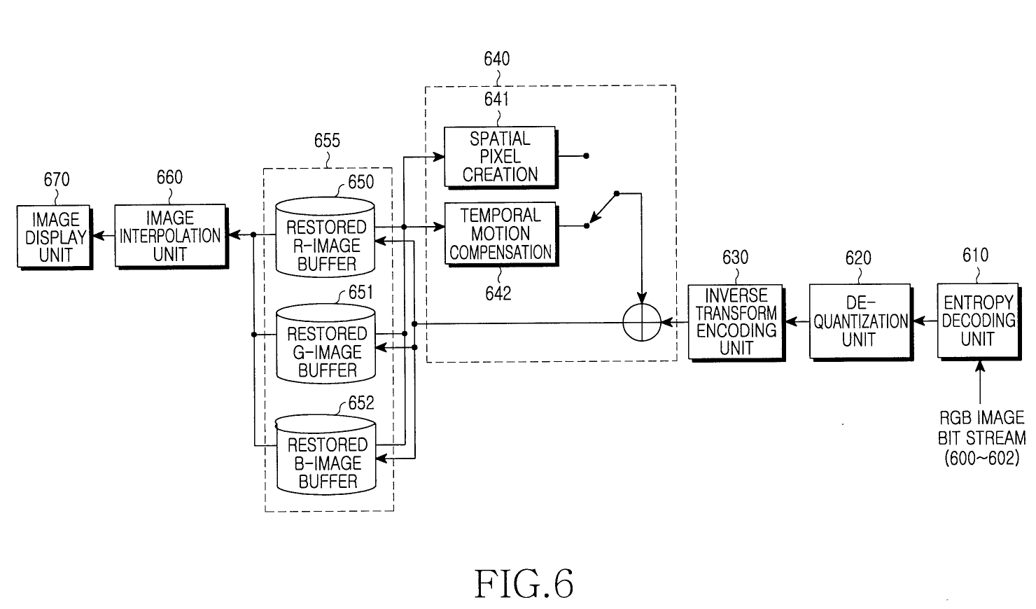

FIG. 6 is a block diagram of a sensor-based video decoding apparatus according to an exemplary embodiment of the present invention. Referring to FIG. 6, the sensor-based video decoding apparatus includes an entropy decoding unit 610, a dequantization unit 620, an inverse transform encoding unit 630, a restored image creation unit 640, a restored image buffer unit 655, an image interpolation unit 660, and an image display unit 670. Functions of the respective elements will be described below with reference to FIG. 6.

The entropy decoding unit 610, the dequantization unit 620 and the inverse transform encoding unit 630 perform decoding to restore an image from received R, G an B image bit streams 600-602. The respective color components can be transformed in different forms of bit streams. The input signal from the inverse transform encoding unit 630 uses transform coefficients having a mosaic form, or uses transform coefficients, the number of which equals the number of pixels of an image to be output.

The restored image creation unit 640 creates a compensated image using the received bit streams and the previously decoded image stored in the restored image buffer unit 655. Like in the encoding apparatus described in connection with FIG. 1, a spatial pixel creation unit 641 creates a compensated image by performing spatial pixel creation using the previously decoded peripheral pixels existing having a mosaic form, and a temporal motion compensation unit 642 creates a compensated image by performing temporal motion compensation using the previously decoded reference image having a mosaic form. The restored image creation unit 640 creates restored R, G and B component images using the restored residual image and the compensated image, and may separately store the restored R, G and B component images in respective color component buffers 650, 651 and 652 of the restored image buffer unit 655.

The image interpolation unit 660 creates a three-color image by interpolating the separately stored color components. An image interpolation method applied in the image interpolation unit 660 may include any of the commonly used interpolation methods of the related art. Finally, the image display unit 670 displays the interpolated three-color RGB image on an external output device.

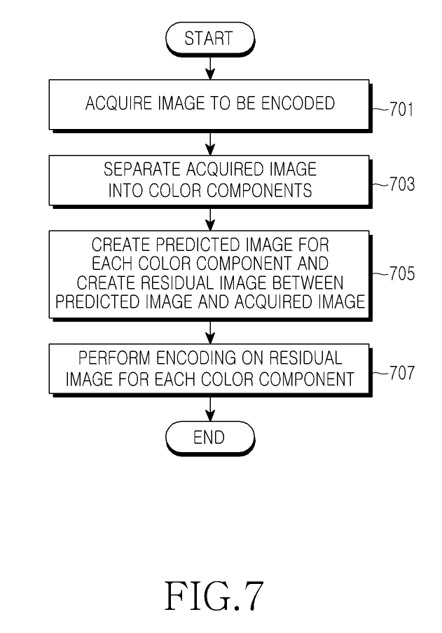

FIG. 7 is a flowchart illustrating a sensor-based video encoding method according to an exemplary embodiment of the present invention.

Referring to FIG. 7, a full-color image is acquired using a camera with a CCD sensor structure in operation 701. This image can be either a moving image or a still image. In operation 703, the acquired image is separated into respective color components, which undergo individual encoding. Here, the image is separated into R, G and B components. In operation 705, predicted images are created for the respective color components, and residual images between the predicted images and the acquired images are created. Temporal and/or spatial pixel prediction is possible for creation of the predicted images, and pixels existing in peripheral blocks and interpolated pixels are used during spatial pixel prediction for an image block. The temporal pixel prediction uses a previous image, and search is made only for the locations having a value in order to find a block for optimal motion prediction. In operation 707, encoding is performed on the determined residual images for the respective color components individually. The encoding is conducted by performing transformation on a 4×4 square input using 8 input pixels. Here, input pixels can be expressed with 8 transform coefficients, the number of which equals the number of input pixels, using the 4×4 integer transformation formula of H.264/AVC.

As described above, according to the exemplary embodiments, it is possible to improve software and/or hardware complexity of the encoding and decoding system by expressing input pixels with only 8 transform coefficients.

As is apparent from the foregoing description, according to the exemplary embodiments, as images based on a video sensor structure are used as input images, the software and/hardware complexity can be improved by expressing input pixels with the minimum number of transform coefficients compared with the number of the input pixels.

Exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, Read-Only Memory (ROM), Random-Access Memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the structure and operation of the video encoding and decoding apparatus and method has been shown and described with reference to certain exemplary embodiments of the invention, it will be understood by those skilled in the art that various changes in form and details may be made therein without departing from the spirit and scope of the invention as defined by the appended claims and their equivalents.

What is claimed is:

1. A method for encoding an image, the method comprising:
acquiring an image to be encoded;
separating the acquired image into color components;
creating a predicted image for each of the color components;
creating a residual image between the predicted image and the acquired image; and
transform encoding each of the color components individually by applying the residual image to a transformation formula.

2. The method of claim 1, wherein the separating comprises dividing the acquired image into a red image, a green image and a blue image, and separately storing the red image, the green image and the blue image.

3. The method of claim 1, wherein the creating the predicted image comprises creating a temporal-predicted image or a spatial-predicted image for an image which is to be presently encoded.

4. The method of claim 3, wherein the creating the spatial-predicted image comprises predicting spatial pixels for a current image block using existing pixels and pixels interpolated based on the existing pixels.

5. The method of claim 4, wherein the interpolated pixels are interpolated using peripheral pixels among the existing pixels.

6. The method of claim 1, wherein the residual image has a mosaic form, and used as an input during the transform encoding.

7. The method of claim 1, wherein the transform encoding comprises:
copying pixels of the residual image in a horizontal direction or a vertical direction;
acquiring a predetermined number of transform coefficients using the transformation formula; and
expressing input pixels with half of the acquired transform coefficients according to a correlation between the acquired transform coefficients.

8. The method of claim 1, further comprising creating a bit stream by quantizing and entropy-encoding the transform-encoded image for each of the color components.

9. A method for decoding an image, the method comprising:
inverse transform encoding each of color components of an image;
creating a restored image using a residual image and a compensated image; and
creating a full-color image by interpolation to display the restored image for each of the color components of the image.

10. The method of claim 9, wherein the inverse transform encoding comprises inverse transform encoding each of the color components of the image using a number of transform coefficients having a mosaic form, the number being equal to a number of pixels of an image to be output.

11. The method of claim 9, wherein the creating the restored image comprises creating the compensated image by performing spatial pixel creation using previously decoded peripheral pixels having a mosaic form, and performing temporal motion compensation using a previously decoded reference image having a mosaic form.

12. The method of claim 9, further comprising prior to the inverse transform encoding, entropy-decoding and dequantizing an image bit stream which is transform-encoded for each of the color components.

13. An apparatus for encoding and decoding an image, the apparatus comprising:
an image acquisition unit which acquires an image to be encoded;
an encoding unit which acquires a predetermined number of transform coefficients by copying pixels of a residual image in a vertical direction or a horizontal direction, and expresses input pixels with half of the acquired transform coefficients according to a correlation between the acquired transform coefficients;
a decoding unit which creates a restored image using a residual image and a compensated image, and interpolates the restored image; and
an image display unit which displays the image interpolated by the decoding unit.

14. The apparatus of claim 13, wherein the encoding unit comprises:
a predicted image creation unit including a temporal motion prediction unit which predicts motion for a location whose value is less than an integer pixel unit using a previously encoded previous image, and a spatial pixel prediction unit which predicts a current image to be encoded, using a peripheral block of the previously encoded current image;
a residual image creation unit which calculates a residual image between an optimal predicted image predicted by the predicted image creation unit and the image to be encoded; and
a motion compensation unit which creates time-dependent prediction information predicted by the temporal motion prediction unit.

15. The apparatus of claim 13, wherein the decoding unit comprises:
a spatial pixel creation unit which creates a compensated image by performing temporal pixel creation using previously decoded peripheral pixels having a mosaic form; and
a temporal motion compensation unit which creates the compensated image by performing temporal motion compensation using a previously decoded reference image having a mosaic form.

16. An apparatus for encoding and decoding an image, the apparatus comprising:
an image acquisition unit which acquires an image to be encoded;
an image separation unit which separates the acquired image into color components;
a predicted image creation unit which creates a predicted image for each of the color components;
a residual image creation unit which creates a residual image between the predicted image and the acquired image; and
a transform encoding unit which transform encodes each of the color components individually by applying the residual image to a transformation formula.

17. The apparatus according to claim 16, wherein the predicted image creation unit comprises:
a temporal motion prediction unit which predicts motion for a location whose value is less than an integer pixel unit using a previously encoded previous image; and
a spatial pixel prediction unit which predicts a current image to be encoded, using a peripheral block of the previously encoded current image.

18. The apparatus according to claim 17, wherein the transform encoding unit acquires a predetermined number of transform coefficients by copying pixels of the residual image in a vertical direction or a horizontal direction, and expresses input pixels with half of the acquired transform coefficients according to a correlation between the acquired transform coefficients.

19. An apparatus for decoding an image, the apparatus comprising:
an inverse transform encoding unit which inverse transform encodes each of color components of an image and outputs a residual image for each of the color components of the image;
a restored image creation unit which creates a restored image for each of the color components using the residual image and a compensated image; and
an image interpolation unit which interpolates the restored image to create a full-color image by interpolation.

20. The apparatus of claim 19, wherein the inverse transform encoding unit inverse transform encodes each of the color components of the image using a number of transform coefficients having a mosaic form, the number being equal to a number of pixels of an image to be output.

21. The apparatus of claim 19, wherein the restored image creation unit comprises:
a spatial pixel creation unit which creates the compensated image by performing temporal pixel creation using previously decoded peripheral pixels having a mosaic form; and
a temporal motion compensation unit which creates the compensated image by performing temporal motion compensation using a previously decoded reference image having a mosaic form.
